(19) United States
(12) Patent Application Publication
(10) Pub. No.: US 2009/0158875 A1
(43) Pub. Date: Jun. 25, 2009

(54) STARGEAR ASSEMBLY

(76) Inventor: Wayne Crooks, Madison, OH (US)

Correspondence Address: PEARNE & GORDON LLP, 1801 EAST 9TH STREET, SUITE 1200, CLEVELAND, OH, 44114-3108, US

(21) Appl. No.: 11/959,488

(22) Filed: Dec. 19, 2007

(51) Int. Cl. F16H 55/17; B65G 17/24

(52) U.S. Cl. 74/436; 198/779

(57) ABSTRACT

A multi-piece stargear assembly comprising a hub, a pair of arcuate toothed segments, and a lock ring, the hub having an internal bore, a keyway in the bore, and an external radially extending flange adjacent one end, the ring being configured to fit on an end of the hub opposite said one end, said segments being arranged around said hub, said flange and segments having mutually interlocking surfaces that enable the flange to resist axial and radial movement on said hub of said segments adjacent said flange, said ring and segments having mutually interlocking surfaces that enable the ring to resist axial and radial movement on said hub of said segments adjacent said ring.

### BACKGROUND OF THE INVENTION

The invention relates to improvements in powered roller conveyors and, in particular, to replaceable drive gears for such conveyors.

### PRIOR ART

Board making processes such as those involved in the manufacture of veneer boards, typically use drying stations that have powered conveyors to transport moisture laden material through a hot air dryer. The conveyors in these applications are generally of the powered roller type with roller pairs driven in unison by meshed gears on respective roller shafts. The gears, sometimes called stargears, owing to their characteristic tooth shape, are subject to high wear rates because they operate in open environments exposed to the materials being conveyed and without the benefit of lubrication.

Conventional dryer conveyor systems are configured such that the components exist in tight quarters and various parts are assembled successively on each roller shaft. The lack of clearance around the parts and the need to remove some parts for access to others makes it very difficult and time consuming to change the stargears in a conventional dryer conveyor. The task of removing and replacing stargears is considerable because associated shaft bearings and in some designs, sprockets must first be removed and this effort is compounded by the sheer number of such gears that exist in the typical dryer. Oftentimes, the sprockets and stargears themselves are oxidized to the roller shafts, making their removal particularly troublesome. From the foregoing brief discussion, it will be understood that there has been a long-standing need for a way to replace worn stargears with less labor and time than has heretofore been necessary.

### SUMMARY OF THE INVENTION

The invention provides a stargear assembly for use in powered roller conveyors that reduces the labor, time and material cost in replenishing worn gear teeth. The stargear assembly, in accordance with the invention, permits the renewal of worn gear teeth while leaving a base hub in place on the roller shaft for re-use with a new set of gear teeth. Since the invention permits the gear teeth to be removed and replaced without disturbing other components including bearings, bearing holders, and sprockets on the roller shafts, considerable savings in labor can be achieved and the risk or need to break or otherwise damage other components can be avoided. Further, the stargear teeth replacement elements, in the form of arcuate segments, are less expensive to produce than prior art pieces since they comprise less material and less machine work is required for their manufacture.

### BRIEF DESCRIPTION OF THE DRAWINGS

FIG. 1 is a schematic view of a pair of power driven rollers at a typical roller station in a dryer conveyor;

FIG. 2 is a perspective view of a stargear assembly constructed in accordance with the invention;

FIG. 3 is a side view, partially in section, of the stargear assembly;

FIG. 4 is an end or axial view of the stargear assembly;

FIG. 5 is an axial view of a hub of the stargear assembly;

FIG. 6 is a side view partially in section, of the hub of FIG. 5;

FIG. 7 is an axial view of a stargear segment of the invention;

FIG. 8 is a side view of the stargear segment of FIG. 7;

FIG. 9 is a cross-sectional view of the stargear segment taken in the plane 9-9 indicated in FIG. 7;

FIG. 10 is a diametral cross-sectional view of a lock ring of the stargear assembly;

FIG. 11 is a diametral cross-sectional view of a modified lock ring; and

FIG. 12 is a longitudinal cross-sectional view of a modified hub.

### DESCRIPTION OF THE PREFERRED EMBODIMENT

The invention resides in a multi-piece stargear assembly particularly suited for use in a roller conveyor 10 such as used in a veneer dryer. For purposes of clarity, only one pair of rollers 11, 12 are shown, but it will be understood that on each level or deck of the dryer, numerous roller pairs are arrayed parallel and closely spaced to one another at successive points or stations along the conveying path. The rollers 11, 12 are mounted on respective shafts 13, 14 which in turn are located in bearing supports 16, 17. The lower shaft, conventionally, is carried in bearings 18 in lower portions of the supports 16, 17, while the upper shaft 14 is confined in upper parts of the supports 16, 17. A chain 21 power drives the lower shaft 13 through a sprocket 19 and similarly drives other sprockets associated with the other roller pairs in the same conveyor level or deck.

A multi-piece stargear assembly 26 of the invention is mounted on each shaft 13, 14 of a roller pair or station. The stargears 26 are meshed with one another and thereby enable some of the power imparted to the associated sprocket 19 to be transferred to the mating upper roller 12 causing it to counter-rotate in synchronization with the lower roller 11 driven directly by the sprocket. The stargear assemblies 26, used on the lower and upper shafts 13, 14, are identical. A stargear assembly 26 has a characteristic long gear tooth profile enabling the gear teeth of mating assemblies to stay engaged with one another while the center-to-center distance between their respective shafts 13, 14 varies somewhat as a function of the presence and the thickness of the web of material passing between the rollers 11, 12.

Each stargear assembly 26 comprises a hub 27, a pair of gear segments 28, and a locking ring 29 all of which can be formed of ductile iron. The hub 27 is cylindrical in its general form with a central cylindrical bore 31 sized to fit closely on a shaft 13 or 14. The bore 31 includes a key slot 32 for receiving a square key that is also received in a corresponding slot in the shaft 13, or 14. The exterior of the hub 27 is concentric with the bore 31 and has a radially extending circular flange 33 at one end, cylindrical arcuate surface segments 34 along its mid-section, and an externally threaded portion 36 on an end opposite the flange 33. The surface segments lie diametrally opposite one another and between a pair of diametrally opposed lugs or stops 37. The lugs extend radially from the cylindrical surface segments 34 to an imaginary cylinder corresponding to an outer surface 38 of the flange 33. One of the lugs 37 has an internally threaded hole 39 to receive a set screw that can bear on a key in the slot 32. An inner radial face 41 of the flange 33 is formed with arcuate grooves 42 of constant rectangular cross-section concentric with the bore 31 and extending from lug 37 to lug 37. The formation of the grooves 42 create arcuate retaining lips 43. The inner sides of the grooves 42 have radii equal to the radius of the cylindrical surface segments 34 at the mid-section of the hub such that they present a smooth continuation of these mid-section surfaces. The axial length of the lugs, measured from the flange 33 is preferably somewhat less than the distance to the threaded portion 36.

The lock ring 29 is a circular element relatively short in its axial direction, and is formed with an internally threaded circular bore 44, an outer cylindrical surface 46 concentric with the bore, and opposite radially extending end faces 47, 48. The threads of the bore 44 are cut to mate with the external threads on the hub 27. The outer cylindrical surface 46 has angularly spaced radially oriented blind holes 49 to receive a wrench by which the lock ring 29 can be tightened or loosened on or off the hub 27. The lock ring 29 has a counter bore 51 at a side or end that forms an inner cylindrical surface 52 and an annular lip or projection 53.

The gear segments 28 are preferably identical and have radially elongated uniformly arcuately spaced teeth 56 being five (5) in number and with a nominal common pitch diameter of 7½″. At the roots of the teeth 56 is an arcuate cylindrical base 57 that serves as a bridge connecting the teeth. An inner cylindrical surface 58 of the base 57 has a radius closely fitting the radius of the hub surface segments 34.

The face width of the teeth 56 is about one-half the axial length of the hub 27. With particular reference to FIGS. 8 and 9, a radial face 61 of the segment 28 has an axially projecting lip 62 that at its inside forms part of the cylindrical surface 58 and that ha a cylindrical outer surface 63. At its opposite radial face 66, the segment 28 has an arcuate groove 67 of constant rectangular cross-section concentric with the interior cylindrical surface 58.

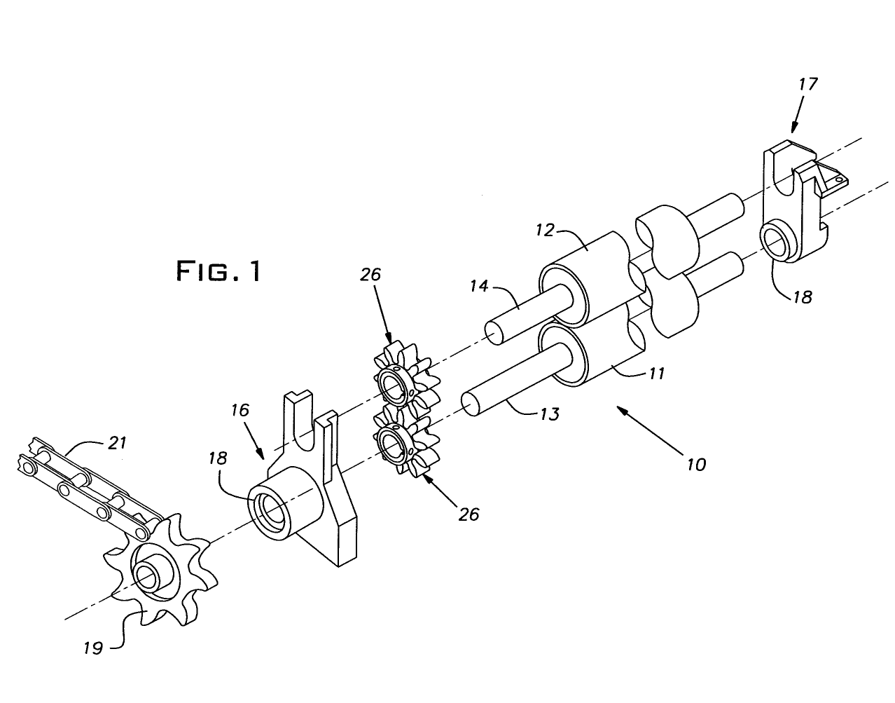

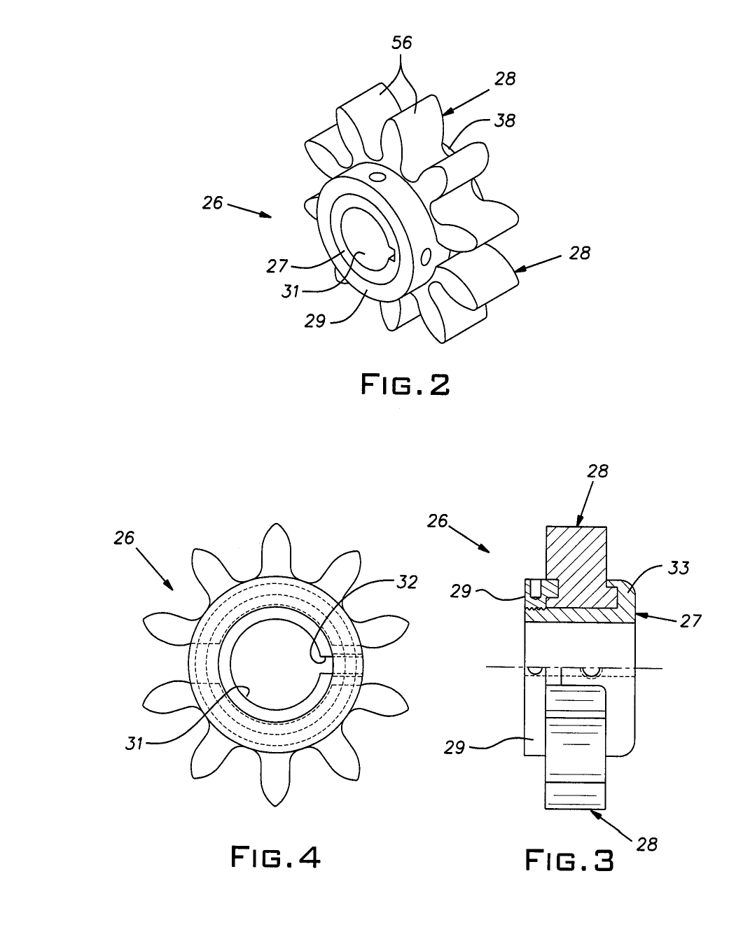

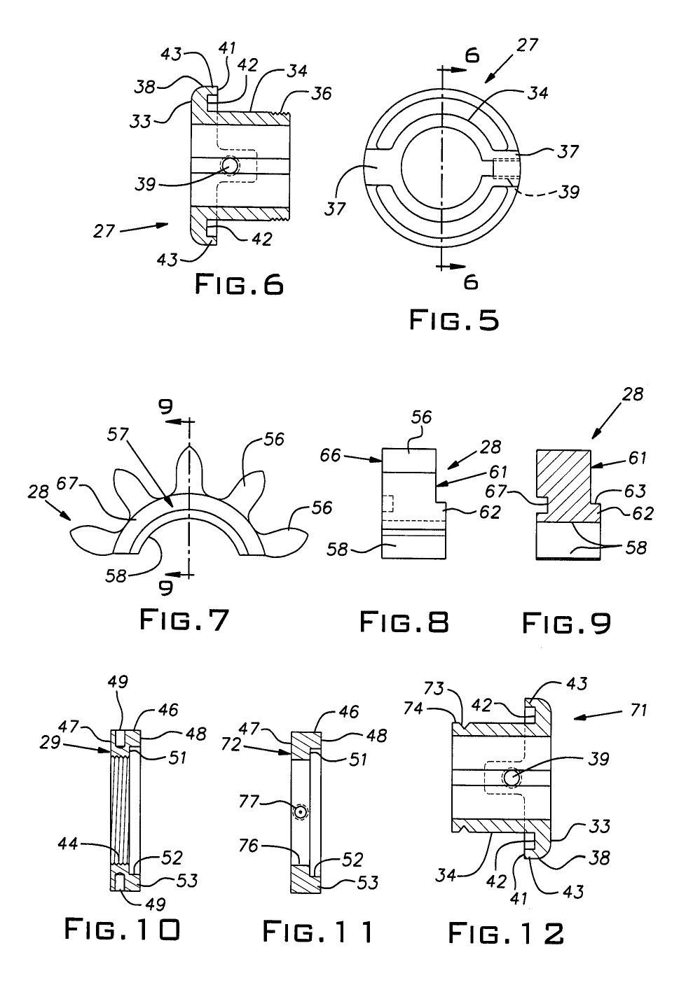

As particularly seen in FIG. 3, the hub 27, gear segments 28, and lock ring 29 are assembled in a manner that locks the segments on the hub. The projecting lip 62 on the radial face 61 of a gear segment fits into the groove 42 on the inner radial face 41 of the hub flange 33. Similarly, the part of the lock ring surrounding the counter bore 51 projects into the groove 67 on the segment base 57. The arcuate length of the gear segment base 57 is complimentary to that of the spacing between the hub lugs 37, such that abutment between the ends of a segment base 57 and the lugs 37 prevents rotation of the segments relative to the hub. When a stargear assembly 26 is first installed on a shaft, the segments 28 and lock ring 29 can already be in place on the hub 27 as described in connection with FIG. 3. The assembly 26 is slipped over a shaft 13 to the correct axial position and locked in place by tightening a set screw in the tapped hole 39. In some conveyor designs such as shown in FIG. 1, the sprocket 19 is outboard of a stargear assembly 26 while in others, the stargear assembly is positioned on the opposite end of a roller from where the sprocket is attached. Typically, the bearings and bearing supports for the rollers 11, 12, are outboard of the stargears.

With use, the stargear segments 28 wear out requiring their replacement, typically at times when other parts at the roller stations are not in need of replacement. The invention permits the gear teeth, when worn out, to be replaced without removal of any associated sprocket 19, bearings 18, or bearing supports 16, 17. Removal of a worn set of gear segments 28 is accomplished, in accordance with the invention, by unscrewing the lock ring 29 away from the gear segments 28 and off of the hub 27. With the ring 29 off the hub 27, the segments 28 can be moved axially away from the hub flange 33 until the projecting lip 62 is completely out of the hub flange groove 42 and is then moved radially completely away from the hub 27. A new set of gear segments 28 can be installed on the hub 27 by reversing this sequence.

When the stargear parts are fully assembled, the gear segments 28 are locked in position against movement on the hub 27 and, consequently, against movement relative to the shaft 13 or 14 on which they are mounted. The fit between the inner cylindrical surface 58 of the gear segment 28 and the outer cylindrical surface segments 34 of the hub prevents radial inward movement of the segments. The interfitting or telescoping relation between the projections and corresponding grooves prevents any outward radial movement or axial tilting movement of the gear segments relative to the hub. Specifically, the hub lips 43 radially restrain the gear segment lips 62 at one side of the segments 28 and the annular ring lip 53 received in the segment grooves 67 radially restrains the other side of the segments. The segments 28 are axially confined by the radial surfaces of the hub flange and lock ring abutting the opposed radial faces of the segments, respectively. Angular movement of the segments 28 on the hub 27 is prevented by abutting contact between the end faces of the segments and the sides of the stop lugs 37 that lie in planes generally chordally oriented with respect to the axis of the hub 27.

FIGS. 11 and 12 illustrate examples of modifications a hub 71 and lock ring 72 of the invention. These hub and lock ring components 71, 72 serve the same functions in assembly with the stargear segments 28 as do the earlier described hub and lock ring components 27 and 29. Structural features of these modified components that are identical with those of the earlier described components are given the same numeral designations as previously used. The hub 71 has a peripheral groove 73 of V-shaped cross-section adjacent its cylindrical end 74 distal from the flange 33. The lock ring 72 has a smooth cylindrical bore 76 sized to slip over the cylindrical end 74 of the hub 71. Diametrally opposed pointed set screws 77 (only one is seen in FIG. 11) are assembled in radial tapped holes in the lock ring 72. The set screws 77, when tightened, extend into and lock on the peripheral groove 73, thereby securing the stargear segments 28 on the hub 71.

It should be evident that this disclosure is by way of example and that various other changes may be made by adding, modifying or eliminating details without departing from the fair scope of the teaching contained in this disclosure. For example, the lock ring, as an alternative to the machine threads of the bore 44 or the set screws 77, can be retained on the hub by a bayonet style connection, by a snap ring, or by other known collar retention arrangements. The invention is therefore not limited to particular details of this disclosure except to the extent that the following claims are necessarily so limited.

What is claimed is:

1. A multi-piece stargear assembly comprising a hub, a pair of arcuate toothed segments, and a lock ring, the hub having an internal bore, a keyway in the bore, and an external radially extending flange adjacent one end, the ring being configured to fit on an end of the hub opposite said one end, said segments being arranged around said hub, said flange and segments having mutually interlocking surfaces that enable the flange to resist axial and radial movement on said hub of said segments adjacent said flange, said ring and segments having mutually interlocking surfaces that enable the ring to resist axial and radial movement on said hub of said segments adjacent said ring.

2. A multi-piece stargear assembly as set forth in claim 1, wherein said hub has abutment surfaces to resist rotation of said segments about said hub.

3. A multi-piece stargear assembly as set forth in claim 1, wherein said segments have extensions that fit into said flange.

4. A multi-piece stargear assembly as set forth in claim 1, wherein said segments have grooves that receive extensions of said ring.

5. A multi-piece stargear assembly as set forth in claim 1, wherein said hub includes a threaded hole to receive a set screw between a pair of abutment surfaces.

6. A multi-piece stargear assembly as set forth in claim 5, wherein said flange and ring have substantially the same outside diameters.

7. A multi-piece stargear assembly as set forth in claim 5, wherein said abutment surfaces are on diametrally opposite locations on said hub.

8. A multi-piece stargear assembly as set forth in claim 1, wherein said mutually interlocking surfaces are concentric with said internal bore.

9. A multi-piece stargear assembly as set forth in claim 1, wherein said lock ring includes formations arranged to receive a wrench to facilitate turning said lock ring on and off said hub.

10. In a powered roller conveyor having a pair of rollers between which a web of material is conveyed, the rollers being mounted on shafts which in turn are carried in bearings, a stargear assembly on each roller shaft adjacent the ends of the rollers and supports for said shafts, the stargear assemblies having a hub fixed to its respective shaft and a pair of identical gear segments removably fixed to the hub such that the segments can be removed from the hub and replaced with new segments when the teeth of said segments have incurred wear through extended operation and said hub remains in place on its respective shaft.

11. A stargear segment with an internal cylindrical mounting surface subtending an arc of less than 180°, five teeth extending radially from the base and having a nominal pitch diameter of 7½ inches, the base having opposite faces transverse to an axis of the cylindrical mounting surface, each of said faces having an associated cylindrical surface area adapted to be used to retain said segment on a hub.
